(19) United States
(12) Patent Application Publication
(10) Pub. No.: US 2025/0193080 A1
(43) Pub. Date: Jun. 12, 2025

(54) SYSTEMS AND METHODS FOR PROVIDING SECURE COMMUNICATION BETWEEN MODEMS

(71) Applicant: Hughes Network Systems, LLC, Germantown, MD (US)

(72) Inventors: Mustafa RANGWALA, New Market, MD (US); Victor Suthirak Srethabhakti LIAU, Gaithersburg, MD (US); Ian Savio DIAS, Oak Hill, VA (US)

(73) Assignee: Hughes Network Systems, LLC, Germantown, MD (US)

(21) Appl. No.: 18/532,839

(22) Filed: Dec. 7, 2023

(51) Int. Cl. H04L 41/0894; H04L 27/12; H04L 27/26; H04L 41/0806

(52) U.S. Cl. CPC H04L 41/0894; H04L 27/12; H04L 27/2603; H04L 41/0806

(57) ABSTRACT

Systems and methods for securing communications between modems are disclosed. The system comprises a modem and an in-line system. The in-line system establishes communication channel with the modem via a communication network. The in-line system receives the legacy signal from the modem upon establishing the communication channel with the modem. The in-line system determines the type of mode of operation associated with the in-line system. The in-line system determines a plurality of configuration parameters associated with the plurality of configurable components of the in-line system. The in-line system configures the plurality of configurable components of the in-line system at real-time with the determined plurality of configuration parameters. The in-line system executes action, in a sequence in each of the configured plurality of configurable components to process the received legacy signal. The in-line system communicates the processed legacy signal to the external device.

### TECHNICAL FIELD

This disclosure is directed to communication systems and, more specifically, to systems and methods for providing secure communication between modems.

### BACKGROUND

Generally, in communication systems, data transmissions are to be constantly monitored for security threats such as unauthorized access, traffic analysis, and jamming attacks. Existing communication systems may implement transmission security (TRANSEC) protocols to address this issue. The TRANSEC protocols may be a multifaceted approach comprising a physical layer security, a link layer security, and a data integrity mechanism. Each layer of security is configured to secure communication channels against a range of security threats. However, a critical issue arises when considering compatibility of the TRANSEC protocols with conventional communication equipment, such as, for example, legacy or conventional modems. These conventional modems lack fundamental support required to implement the TRANSEC protocols and frequency hopping protocols. This may be due to outdated design and inherent limitations of the conventional modems. Specifically, the conventional modems may lack the requisite architecture and capabilities to implement the security measures required to achieve the TRANSEC protocol. As a result, the conventional modems are unable to encrypt all transmitted data and headers at the physical layer, verify the integrity of transmitted information, or establish secure links at the link layer. This deficiency of the conventional modem may expose the communication channels to potential eavesdropping and unauthorized access.

Further, conventional modems may lack the capability to implement frequency hopping due to fixed frequency communication. Due to this, conventional modems may be susceptible to certain types of jamming or interference attacks. Furthermore, conventional modems operating on static and predictable communication patterns may be susceptible to traffic analysis. Moreover, conventional modems may lack mechanisms to verify the integrity of transmitted data. Therefore, such conventional modems may be susceptible to security threats.

Consequently, there may be a need for an improved system and method to secure communications between the modems to address the issues.

### SUMMARY

This summary is provided to introduce a selection of concepts which are further described in the detailed description of the disclosure. This summary is neither intended to identify essential inventive concepts of the subject matter nor to determine the scope of the disclosure.

An aspect of the present disclosure provides a system for securing communication between modems. The system comprises a modem to communicate a legacy signal with an external device. The legacy signal comprises at least one of an analog signal and a digital signal. Further, the system comprises an in-line system communicatively connected with the modem and the external device. The in-line system comprises a plurality of configurable components, a processor; and a memory coupled to the processor. The in-line system establishes a communication channel with the modem via a communication network. The in-line system receives the legacy signal from the modem, upon establishing the communication channel with the modem. The legacy signal comprises signal information, a channel requirement, and a modem configuration information. The in-line system determines a type of mode of operation associated with the in-line system based on the received legacy signal and the channel requirement. The in-line system determines a plurality of configuration parameters associated with the plurality of configurable components of the in-line system based on the determined type of mode of operation. The in-line system configures the plurality of configurable components of the in-line system at real-time with the determined plurality of configuration parameters. The in-line system executes at least one action, in a sequence in each of the configured plurality of configurable components to process the received legacy signal. The at least one action is determined based on the determined plurality of configuration parameters and the mode of operation. The in-line system communicates the processed legacy signal to the external device via the established communication channel. The communication channel comprises at least one of a random channel activity and a uniform channel activity associated with in-line system.

Another aspect of the present disclosure provides a method for securing communications between modems. The method includes establishing a communication channel between a modem and an in-line system via a communication network. Further, the method includes receiving a legacy signal from the modem, upon establishing the communication channel with the modem. The legacy signal comprises signal information, a channel requirement, and a modem configuration information. The method includes determining a type of mode of operation associated with the in-line system based on the received legacy signal and a channel requirement. The method further includes determining configuration parameters associated with the plurality of configurable components of the in-line system based on the determined type of mode of operation.

Further, the method includes configuring a plurality of configurable components of the in-line system at a real-time with the determined plurality of configuration parameters Furthermore, the method includes executing in a sequence in each of the configured plurality of configurable components to process the received legacy signal. The at least one action is determined based on the determined plurality of configuration parameters and the mode of operation. Additionally, the method includes communicating the processed legacy signal, via a communication channel to the external device. The communication channel comprises at least one of a random channel activity and a uniform channel activity associated with an in-line system.

Yet another aspect of the present disclosure provides a non-transitory computer-readable medium comprising machine-readable instructions that are executable by a processor. The processor establishes a communication channel with the modem via a communication network. The processor receives the legacy signal from the modem, upon establishing the communication channel with the modem. The legacy signal comprises a signal information, a channel requirement, and a modem configuration information. The processor determines a type of mode of operation associated with the in-line system based on the received legacy signal and the channel requirement. The processor determines a plurality of configuration parameters associated with the plurality of configurable components of the in-line system based on the determined type of mode of operation. The processor configures the plurality of configurable components of the in-line system at real-time with the determined plurality of configuration parameters. The processor executes at least one action, in a sequence in each of the configured plurality of configurable components to process the received legacy signal. The at least one action is determined based on the determined plurality of configuration parameters and the mode of operation. The processor communicates the processed legacy signal to the external device via the established communication channel. The communication channel comprises at least one of a random channel activity and a uniform channel activity associated with an in-line system.

To further clarify the features of the present disclosure, a more particular description of the disclosure will follow by reference to specific examples thereof, which are illustrated in the appended figures. It is to be appreciated that these figures depict only typical examples of the disclosure and are therefore not to be considered limiting in scope. The disclosure will be described and explained with additional specificity and detail with the appended figures.

### BRIEF DESCRIPTION OF DRAWINGS

Features of the disclosed examples are illustrated by way of example and not limited in the following Figure(s), in which like numerals indicate like elements, in which:

FIG. 1 illustrates an example block diagram representation of a communication network capable of providing secure communication between modems, according to an example.

FIG. 2 illustrates an example block diagram representation of an in-line system, such as that shown in FIG. 1, capable of providing secure communication between modems, according to an example.

FIG. 3A-B illustrates an example block diagram representation of an in-line system, such as that shown in FIG. 1, depicting detailed view of internal components within the system, according to an example.

FIG. 4 illustrates an example block diagram representation of a transmitter side in-line system and a receiver side in-line system, according to an example.

FIG. 5 illustrates an example flow diagram representation depicting interactions between a modem, an in-line system, and an antenna, according to an example.

FIG. 6 illustrates an example flow diagram representation of a method for providing secure communication between modems, according to an example.

Further, those skilled in the art will appreciate those elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the examples of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the example illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are example and explanatory of the disclosure and are not intended to be restrictive thereof.

In the present document, the word “example” is used herein to mean “serving as an example, instance, or illustration”. Any example or implementation of the present subject matter described herein as “example” is not necessarily to be construed as preferred or advantageous over other examples. The terms “comprise,” “comprising,” or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an example”, “in another example”, “in an example” and similar language throughout this specification may, but not necessarily do, all refer to the same example.

Unless otherwise defined, all technical and scientific terms used herein have the same meaning as commonly understood by those skilled in the art to which this disclosure belongs. The system, methods, and examples provided herein are illustrative and not intended to be limiting. A computer system (standalone, client, server, or computer-implemented system) configured by an application may constitute a “module” (or “subsystem”) that is configured and operated to perform certain operations. In one example, the “module” or “subsystem” may be implemented mechanically or electronically, so a module includes dedicated circuitry or logic that is permanently configured (within a special-purpose processor) to perform certain operations. In another example, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Examples of the present disclosure provide systems and methods for securing communications between modems. The system comprises a modem to communicate a legacy signal with an external device. The legacy signal comprises at least one of an analog signal and a digital signal. Further, the system comprises an in-line system communicatively connected with the modem and the external device. The in-line system comprises a plurality of configurable components, a processor; and a memory coupled to the processor. The in-line system establishes a communication channel with the modem via a communication network. The in-line system receives the legacy signal from the modem, upon establishing the communication channel with the modem. The legacy signal comprises a signal information, a channel requirement, and a modem configuration information. The in-line system determines a type of mode of operation associated with the in-line system based on the received legacy signal and the channel requirement. The in-line system determines a plurality of configuration parameters associated with the plurality of configurable components of the in-line system based on the determined type of mode of operation. The in-line system configures the plurality of configurable components of the in-line system at a real-time with the determined plurality of configuration parameters. The in-line system executes at least one action, in a sequence in each of the configured plurality of configurable components to process the received legacy signal. The at least one action is determined based on the determined plurality of configuration parameters and the mode of operation. The in-line system communicates the processed legacy signal to the external device via the established communication channel. The communication channel comprises at least one of a random channel activity and a uniform channel activity associated with in-line system.

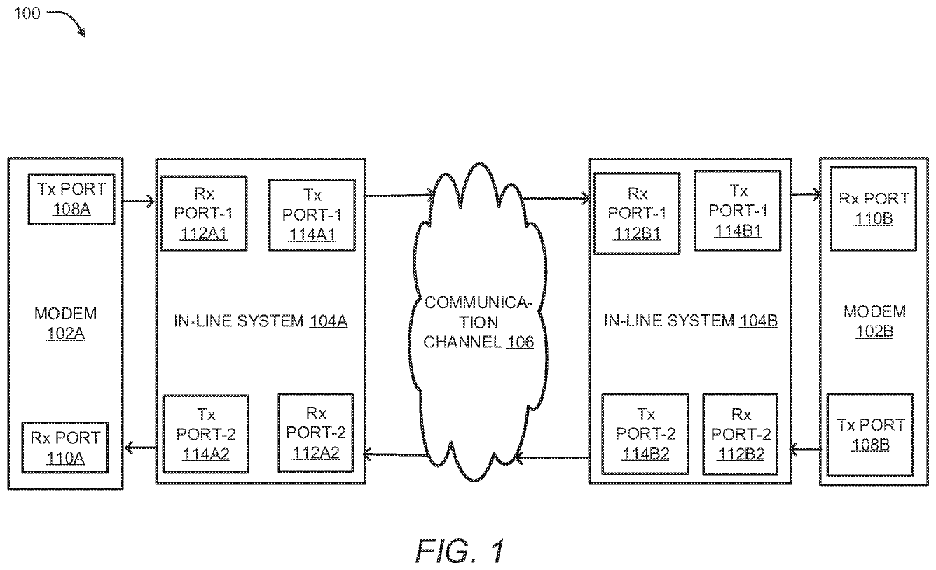

Referring now to the drawings, and more particularly to FIG. 1 through FIG. 6, where similar reference characters denote corresponding features consistently throughout the figures, there are shown preferred examples, and these examples are described in the context of the following example system and/or method.

FIG. 1 illustrates an example block diagram representation of a communication network 100 capable of providing secure communication between modems 102, according to an example. The communication network 100 includes a transmitter side modem 102A and a receiver side modems 102B. The transmitter side modem 102A (also referred to as “modem 102” herein) may be communicatively connected to a transmitter side in-line system 104A (also referred herein as “in-line system 104”) over a wired/wireless communication channel (not shown in FIG. 1). The transmitter side in-line system 104A may be further connected to a receiver side in-line system 104B via a communication channel 106. At the receiver side, the receiver side in-line system 104B (also referred herein as “in-line system 104”) may be connected to the receiver side modems 102B (also referred to as “modem 102” herein) over a wired/wireless communication channel (not shown in FIG. 1).

The modems 102 may be configured to support technologies such as, inter alia, Second Generation (2G) technologies, Third Generation (3G) technologies, Global System for Mobile Communications (GSM) technologies, Code division Multiple Access (CDMA) technologies, Wideband Code Division Multiple Access (W-CDMA) technologies, Time Division Multiplexing (TDM) technologies, Time Division Multiple Access (TDMA) technologies, Frequency Division Multiplexing (FDM) technologies, Frequency Division Multiple Access (FDMA) technologies and the like.

In some examples, modems 102 may include, for example, but not limited to, commercial modems (such as for e.g., consumer and enterprise) operating in benign commercial environments. In some examples, a One Web enterprise modem with the in-line system 104 may support satellite communication requiring department of defense grade transmission security.

In some examples, modems 102 may include as non-limiting examples, modems developed by corporations for their consumer. In such examples, the use of the in-line system 104 may comply with transmission security requirements applicable to government environments.

In some examples, the modems 102 may be configured to communicate with a nearby cellular tower to establish a connection with the communication channel 106. This connection may be necessary to transmit and receive data. Further, the modems 102 may be configured to encode and modulate the data to be transmitted according to specifications of respective network (such as for example, 2G or 3G). This prepares the data for transmission over the airwaves. Further, the modems 102 may transmit the modulated data over wired or radio waves to the in-line system 104.

In an example, the transmitter side modem 102A may be configured to generate a legacy signal to be transmitted to an external device. In some examples, the external device may be a transmitter side in-line system 104A, or a receiver side modems 102B. In alternate example, the external device may be the receiver side in-line system 104B. The legacy signal may include at least one of an analog signal and a digital signal. The transmitter side modem 102A may act as a backend transmitter for transmitting the processed legacy signal.

In an example, the transmitter side modem 102A with the transmitter side in-line system 104A may be referred herein as a transmitter side or a transmitter. Similarly, the receiver side modems 102B with the receiver side in-line system 104B may be referred herein as a receiver side or a receiver.

In an example, the receiver side modems 102B may be configured to receive the transmitted signal via the receiver side in-line system 104B. The receiver side in-line system 104B may act as a front-end receiver for receiving the transmitted signal.

The in-line system 104 may include a plurality of configurable components, a processor; and a memory coupled to the processor. The in-line system 104 may act as an add on device to the modems 102 in order to avoid modification to the modems 102. In an example, the plurality of configurable components may include sampling or de-sampling, compression or decompression, encoder-modulator or demodulator-decoder or standalone modulator, demodulator functions, encryption, or decryption, spreading or dispreading, and frequency hopping or frequency de-hopping and other such functionality.

The in-line system 104 may be configured to address a physical layer security by performing frequency hopping and randomized data upon the received legacy signal based on the need. Further, the in-line system 104 may be configured to address the link layer security by performing encryption mechanisms. Furthermore, the in-line system 104 may be configured to address data integrity of the legacy signal by performing upper layer encryption (such as for example, network layer and above).

In some examples, the in-line system 104 operates at an intermediate frequency (IF), such as for example, but not limited to, a L-Band. The in-line system 104 may be deployed in a transmit and a receive path between the modem 102 and an antenna system (not shown in FIG. 1).

In some examples, in the transmit path, the in-line system 104 may be configured to add randomized data, perform the frequency hopping and the data encryption (such as, for example, but not limited to AES 128/256) on the received legacy signal. In the receive path, the in-line system 104 may be configured to remove the randomized data, de-hops the legacy signal and decrypts the data encryption.

In some examples, the in-line system 104 may be configured to dynamically adjust security parameters of the communication channel 106 based on security threat assessments. The security parameters may include, for example, sampling rate, symbol timing, a burst timing, a frequency offset, a phase offset, a UW(s), a modulation/demodulation scheme, a center frequency, a symbol rate, a reception forward error correction rate (FEC), a reception roll off, a reception signal power and the like.

Further, the in-line system 104 may employ a combination of encryption, a channel activity management, and a mutual authentication mechanism for providing security to the data transmitter over the communication network 100. Further, the in-line system 104 may regulate the channel activity to exhibit either a randomized or uniformly distributed pattern, eliminating any detectable patterns. This suppression of activity patterns acts as a defense against traffic analysis attempts.

In some examples, the in-line system 104 may perform mutual authentication between terminals and hubs (not shown in FIG. 1) within the communication network 100. In some examples, the in-line system 104 may receive the legacy signal from the modem 102. The in-line system 104 may perform analog to digital conversion of the received legacy signal. Further, the in-line system 104 may process the digitized signal using an in-phase/quadrature (I/Q) processing mechanism. The I/Q processing mechanism may refine the digital signal by separating the digital signal into their respective in-phase and quadrature components. This may enable advanced signal manipulation for enhanced performance. Further, the in-line system 104 may perform demodulation of the processed digital signal. Further, the in-line system 104 may transform the demodulated signals into a plurality of symbols, also referred to as encoded bits, representing discrete units of information. Furthermore, the in-line system 104 may encrypt the symbols to generate E-symbols representing secured form of the original data, which is the legacy signal.

Further, the in-line system 104 may apply forward error correction (FEC) encoding by adding redundant information, allowing for error detection and correction during reception of the legacy signal. In some examples, FEC coding may be used to improve the performance of the communication network 100.

In an example, for achieving efficient symbols to encryption, encryption to E-Symbols and then performing FEC encoding may involve considering factors such as for example, E-Symbol and FEC overhead. Further, alternatives such as in-line source FEC decoding may be considered. Additionally, optimizing data rates, symbol rates, and power levels may contribute to more efficient data transmission. The E-Symbols may typically contain more bits due to factors such as padding and encryption header (e.g., CTR, I/V). This increase in size introduces additional overhead in the transmission process. In some other examples, the addition of Forward Error Correction (FEC) may introduce an increased overhead. Considering a legacy signal with a 1/3 FEC, this results in a 67% overhead. Adding another 1/3 FEC to the legacy signal increases the overhead significantly. For every 1 data bit, there are now 4 FEC bits, representing approximately 1/5 of the total, resulting in an 80% overhead.

To mitigate the increased overhead, the transmitter side in-line system 104A may further perform a source FEC decoding. This approach aims to reduce the overall overhead and optimize the transmission process. Further, if more data is required to be transmitted and there is flexibility in terms of time, the transmitter side in-line system 104A may reduce the data rates to manage the overhead effectively. Lower data rates allow for a more efficient transmission process with reduced overhead. Alternatively, the transmitter side in-line system 104A may increase the symbol rate and power to transmit additional data in a given time frame, to offset the overhead introduced by encryption and FEC.

Furthermore, the in-line system 104 may modulate the FEC encoded E-Symbols onto a carrier wave for efficient transmission over the communication channel 106. Further, the in-line system 104 may convert the modulated signal into analog format for transmission over the communication channel 106.

Further, the in-line system 104 may be provided with a unique word (UW) mechanism. In some examples, a transmitter such as the modem 102A may transmit a burst mode signal at a certain frequency, phase, and timing, which is received by a receiver, such as the modem 102B through a communication channel 106. In such burst mode communication systems, it is necessary to estimate various parameters of the received bursts as they arrive. These parameters may include detection of the presence of a burst (start time), frequency, initial phase, timing, and amplitude. The unique word is used to facilitate the identification of the beginning of a transmitted burst and the determination of phase offset, by the receiver. The term “Unique Word” (UW) refers to a known, pre-determined pattern (known a priori to the receiver) that is transmitted at the beginning of each burst, whereby the receiver detects the UW and synchronizes with the received bursts (i.e., the receiver estimates the burst parameters based on the detected UW).

The UW provides a mechanism for the receiver (e.g., receiver-side in-line system 104B) to synchronize on the frame boundaries, and accordingly locate the data payload within each frame. The data payload includes the data and information intended to be received and processed by the destination receiver. By way of example, the receiver receives the transmitted signal, which comprises a series of physical layer data frames. Further, the receiver possesses a priori knowledge of the UW sequence(s) utilized by the respective transmitting terminal(s). The receiver can then search for the respective UW(s) by performing a correlation operation. Once a threshold has been met for the correlation operation, the receiver determines a starting time for the first symbol of the respective UW. Based on the determined starting time for the initial UW symbol, the receiver has thus also determined the initial time of reception or start of the respective physical layer data frame. The receiver can then synchronize and process the symbols of the respective data payload based on the determined initial time of reception or start of the respective physical layer data frame.

In some examples, the in-line system 104 may modulate the legacy signal in accordance with a desired transmission scheme. Furthermore, the in-line system 104 may include power-level control mechanisms to regulate the strength of the transmitted signal. Additionally, the in-line system 104 may be directly connected to the original transmitter, such as the transmitter side modem 102A. The direct connection facilitates accurate symbol timing, burst timing, and mitigates any frequency or phase offsets that may arise.

The communication channel 106 may be for example, but not limited to a single channel per carrier (SCPC) communication channels. In some examples, network traffic within the SCPC channel may be subjected to encryption algorithms. This ensures that even if unauthorized entities gain access to the communication channel 106, the intercepted data remains indecipherable, maintaining the confidentiality of communication.

In an example, the transmitter side in-line system 104A may be configured with a range of configurable input parameters, such as for example, but not limited to unique words (UW), a transmit (Tx) power level, a modulation scheme, a transmit center frequency (Tx Center Freq), a transmit roll-off (Tx Rolloff), a transmit symbol rate (Tx Symbol Rate), a transmit forward error correction rate (Tx FEC Rate), and optionally, an in-line transmit frequency (In-line Tx Transmit Freq). In an example, the receiver side in-line system 104B may be configured with a range of configurable input parameters such as for example, but not limited to, a receiver carrier frequency, the unique words, a demodulation scheme, a receive symbol rate, a receive roll off, a receive forward error correction rate, and a receiver power level.

The transmitter side in-line system 104A and the receiver side in-line system 104B may include a transmitter port 108A and a receiver port 110A. Therefore, each of the transmitter side in-line system 104A and the receiver side in-line system 104B may act as a transceiver. At the transmission side, a first receiver port 112A1 of the transmitter side in-line system 104A is connected to the transmitter port 108A of the modem 102A. Further, the first transmission port 114A1 of the transmitter side in-line system 104A is connected to a first receiver port 112B1 of the receiver side in-line system 104B via the communication channel 106. Similarly, a second receiver port 112A2 of the transmitter side in-line system 104A is connected to a second transmission port 114B2 of the receiver side in-line system 104B via the communication channel 106. Furthermore, a second transmission port 114A2 of the transmitter side in-line system 104A is connected to a receiver port 110A of the modem 102A.

In an example, during data transmission, the legacy signal is transmitted from the transmitter port 108A of the modem 102A to the first receiver port 112A1 of the transmitter side in-line system 104A. Upon digitalization at the transmitter side in-line system 104A, the digitized signal is transmitted from the first transmission port 114A1 of the transmitter side in-line system 104A to the first receiver port 112B1 of the receiver side in-line system 104B via the communication channel 106.

In an example, a response to the digitized signal is received at the second receiver port 112A2 of the transmitter side in-line system 104A from the second transmission port 112B2 of the receiver side in-line system 104B via the communication channel 106. The digitized signal is processed and forwarded to the receiver port 110A of the modem 102A from the second transmission port 114A2 of the transmitter side in-line system 104A.

At the receiver side, the first receiver port 112B1 of the receiver side in-line system 104B is connected to the first transmission port 114A1 of the transmitter side in-line system 104A via the communication channel 106. Similarly, the second transmission port 114B2 of the receiver side in-line system 104B is connected to the second receiver port 112A2 of the transmitter side in-line system 104A via the communication channel 106. Furthermore, the second receiver port 112B2 of the receiver side in-line system 104B is connected to the transmission port 108B of the modem 102B. Similarly, the first transmitter port 114B1 of the receiver side in-line system 104B is connected to the receiver port 110B of the modem 102B.

In some examples, the communication network 100 may depict a wireless/satellite communication system capable of securing communication between modems 102. In some examples, the wireless/satellite communication system may be a third-generation partnership project (3GPP) standard-based terrestrial system, and non-terrestrial systems such as, but are not limited to, low earth orbiting (LEO) satellites, medium earth orbiting (MEO) satellites, geosynchronous earth orbiting (GEO) satellites, and/or other satellite types.

The communication channel 106 may include, but are not limited to, a multi-service access network (MSAN) (such as a digital subscriber line (DSL), a passive optical network (PON), or ethernet), a wireless mesh network (such as wireless fidelity (Wi-Fi), worldwide interoperability for microwave access (WiMAX), or cellular), a hybrid fiber-coaxial (HFC) network, a multi-access edge computing (MEC) network (such as cellular, Wi-Fi, and wired connections), a software-defined wide area network (SD-WAN) (such as multiprotocol label switching (MPLS), broadband internet, and cellular networks). Further, the communication channel 106 may include, but is not limited to, an Internet of things (IoT) network (cellular, low-power wide-area network (LPWAN), Wi-Fi, or Ethernet), a hybrid Network (such as a mixture of fiber optics, DSL, cable, and wireless connectivity options), a campus network (such as ethernet, fiber optics, wireless technologies (e.g., Wi-Fi)), a metropolitan area network (MAN) (such as fiber optics, ethernet, MPLS, and wireless connections), a carrier-grade network (such as fiber optics, DSL, cable, wireless (such as 4G/5G cellular networks), and satellite), a mobile network operators (MNOs) (such as 2G, 3G, 4G LTE, 5G, new radio (NR) and 6G), a power line communication (PLC) network, any other network, and a combination thereof. Further, the communication channel 106 may include, but is not limited to, an internet, multiprotocol label switching (MPLS), leased lines, virtual private networks (VPNs), wireless WAN (WWAN), satellite networks, frame relay and asynchronous transfer mode (ATM) networks, any other network, and a combination thereof.

In an example, the in-line system 104 may be implemented as a standalone device such as a networking apparatus or device. In another example, the in-line system 104 may be implemented and integrated into an existing network device/network apparatus such as a modem 102, a mobile terminal, a user equipment (UE), and/or web/cloud server.

In some examples, the communication network 100 may also include a private network and/or public network (not shown in FIG. 1). The private network and/or public network may include any variations of networks. For example, the private network may be a local area network (LAN), and the public network may be a wide area network (WAN). Also, the private network and/or public network may each be a local area network (LAN), wide area network (WAN), the Internet, a cellular network, a cable network, a satellite network, or other networks that facilitate communication between the components of the communication network 100 as well as any external element or system connected to the private network and/or public network. The private network and/or public network may further include one, or any number, of the example types of networks mentioned above operating as a stand-alone network or in cooperation with each other. For example, the private network and/or public network may utilize one or more protocols of one or more clients or servers to which they are communicatively coupled. The private network and/or public network may facilitate the transmission of data according to a transmission protocol of any of the devices and/or systems in the private network and/or public network. Although each of the private network and/or public networks may be a single network, it should be appreciated that in some examples, each of the private network and/or public networks may include a plurality of interconnected networks as well.

Further, the communication network 100 may include user terminals (not shown in FIG. 1) which may be used by but are not limited to, a user, a customer, an administrator, a network operator, a media content operator, an over-the-top (OTT) operator, any other operator, and/or type of users. Although the user terminal may typically remain in the same location once mounted, the user terminal may be removed from their mounts, relocated to another location, and/or may be configured to be mobile terminals. For example, the user terminal may be mounted on mobile platforms that facilitate transportation thereof from one location to another. Such mobile platforms may include, for example, any number of mobile vehicles, such as airplanes, cars, buses, boats, trucks, troop carriers, or other vehicles, and/or other types of vehicles/commuting means. It should be appreciated that such terminals may generally be operational when still and not while being transported. That said, there may be scenarios where the terminals may be transportable (mobile) terminals that remain operational during transit. As used herein, the terms “terminal”, “customer terminal”, “satellite terminal”, “very small aperture terminal (VSAT)”, and/or “user terminal”, may be used interchangeably to refer to these terminal types.

Further, the satellite (not shown in FIG. 1) may be an object intentionally placed into orbit. In some examples, the satellite may be an artificial satellite that may be configured to transmit and receive data signals. For example, the satellite may form one or more beams (e.g., spot beams) and provide connectivity between the user equipment and the in-line system 104. More specifically, the satellite may communicate data signals using these beams with the terminals via a terminal return channel and a terminal forward channel, and with the gateway via a gateway return channel and a gateway forward channel (not shown). It should be appreciated that the satellite may from any number of beams to communicate data signals with any number of components, even beyond the terminals or the gateway.

In some examples, the communication network 100 may include airborne or spaceborne vehicles (not shown in FIGs). For example, the non-terrestrial networks (NTN) refer to networks, or segments of networks, using an airborne or spaceborne vehicle for transmission. In some examples, the airborne vehicles refer to High Altitude Platforms (HAPs) encompassing Unmanned Aircraft Systems (UAS). The UAS may include for example, a tethered UAS, a Lighter than Air UAS and a Heavier than Air UAS. Each of these UASs operates at altitude; between an example range of 8 km and 50 km, quasi-stationary.

While the processors, components, elements, systems, subsystems, and/or other computing devices may be shown as single components or elements, one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the communication network 100, and components, as shown in FIG. 1.

In an example, the in-line system 104 may include an application (not shown). The application may include, but is not limited to, hypertext transfer protocol (HTTP) components, web application frameworks, content management systems (CMS), server-side scripting languages, authentication and authorization modules, web services, and application programming interfaces (APIs), caching and load balancing mechanisms, e-commerce applications, social media platforms, over-the-top (OTT) applications, any other applications, and a combination thereof.

In an example, the in-line system 104 may include a processor (not shown in FIG. 1) and a memory (not shown in FIG. 1) operatively coupled with the processor. The memory includes processor-executable instructions in the form of the plurality of modules. The processor executes the plurality of modules to perform a plurality of steps described below.

In an example, the plurality of modules at the in-line system 104 may establish a communication channel between the modem 102A and the transmitter side in-line system 104A via a communication network 100. The in-line system 104 may further receive the legacy signal from the modem 102 upon establishing the communication channel with the modem 102. The legacy signal may include signal information, a channel requirement, and a modem configuration information. The signal information may include amplitude variations, phase shifts, and other relevant signal attributes and the like. The channel requirement may include bit rate, sampling rate, data speed, communication protocol, network upgrade, or any specific demands and preferences for the communication channel to be established. The modem configuration information may include operational settings, modulation schemes, and other relevant parameters.

The in-line system 104 may determine a type of mode of operation associated with the in-line system based on the received legacy signal and the channel requirement. The type of mode of operation comprises direct sample processing with compression or de-compression techniques, encoder-modulator/demodulator-decoder or standalone modulator/demodulator functions, encryption/decryption, spreading/dispreading, and frequency hopping/frequency de-hopping and the like. The modes may be dependent on a particular type of legacy signal received. The selection of one or more modes in the pipeline may be setup via prior configuration in the in-line system 104.

The in-line system 104 may determine a plurality of configuration parameters associated with the plurality of configurable components of the in-line system based on the determined type of mode of operation. The plurality of configuration parameters may include, such as, but not limited to, at least one of a symbol timing, a burst timing, a frequency offset, a phase offset, a UW(s), a modulation/demodulation scheme, a center frequency, a symbol rate, a reception forward error correction rate (FEC), a reception roll off, and a reception signal power or a combination thereof. In some examples, the plurality of configuration parameters may be configured based on information associated with the legacy signal. In some examples, the plurality of configuration parameters may be pre-stored.

In one example, a Fourier Transform may be used to determine hopping frequencies and a frequency offset. Further, time samples may provide eye opening which may further determine a symbol timing. In some examples, an angle and an amplitude of a centroid of the symbols may imply a modulation constellation.

Further, the in-line system 104 may configure the plurality of configurable components of the in-line system at real-time with the determined plurality of configuration parameters. Further, the in-line system 104 may execute at least one action, in a sequence in each of the configured plurality of configurable components to process the received legacy signal. The at least one action is determined based on the determined plurality of configuration parameters and the mode of operation.

Furthermore, the in-line system 104 may communicate the processed legacy signal to the external device via the established communication channel 106. The communication channel 106 may include at least one of a random channel activity and a uniform channel activity associated with in-line system 104.

In an example, at the transmitter side, the at least one action may include for example, but not limited to sampling the received legacy signal from the analog signal to the digital signal (A/D), to output a sampled signal corresponding to the legacy signal. Further, the at least one action may include determining at least one of a legacy signal recovery action and a compression to be performed on the sampled signal. The legacy signal recovery action comprises a demodulating action and a decoding action. Furthermore, the at least one action may include extracting the signal information from the sampled signal by performing at least one of the legacy signal recovery action and the compression, based on the determination. The signal information comprises a plurality of symbols. Furthermore, the at least one action may include encrypting the signal information of the sampled signal, based on the at least one of the legacy signal recovery action and the compression performed. Moreover, the at least one action may include ingesting the encrypted signal information onto the communication channel by encoding and modulating the encrypted signal information using a modulating scheme. Furthermore, the at least one action may include classifying the modulated signal information into a plurality of symbols based on content of the modulated signal information. Furthermore, the at least one action may include modifying a transmission frequency associated with the legacy signal over a time interval by performing frequency hopping on the classified plurality of symbols. Additionally, the at least one action may include generating a re-sampled signal corresponding to the legacy signal based on the modified transmission frequency. The re-sampled signal comprises frequency hopped symbols.

In some examples, at the receiver side, the at least one action may include for example, but not limited to: sampling a re-sampled signal from the analog signal to the digital signal (A/D), to output a sampled signal corresponding to the legacy signal. Further, the at least one action may include modifying a transmission frequency associated with the sampled signal over a time interval by performing frequency de-hopping of a spread symbols associated with the sampled signal. Further, the at least one action may include de-classifying the frequency de-hopped spread symbols into a plurality of symbols. Furthermore, the at least one action may include demodulating and decoding the de-spread symbols into the signal information of the legacy signal. Additionally, the at least one action may include determining at least one of a legacy signal generation action and a decompression to be performed based on the signal information. The legacy signal generation action may include a modulating action and an encoding action. The signal information may be in a decrypted form. Furthermore, the at least one action may include performing at least one of the legacy signal generation action and the decompression on the legacy signal based on the determination. Moreover, the at least one action may include outputting the legacy signal by re-sampling the sampled signal comprising the decrypted signal information from the digital signal to the analog signal (D/A).

In some examples, the in-line system 104 may determine a plurality of frame formats associated with the legacy signal. In one example, the plurality of frame formats may be a configuration setting. The plurality of frame formats may include at least one of a time slot and a burst code block. The time slot corresponds to specific time intervals for a data transmission. Further, the in-line system 104 may shift a carrier frequency (CF) within the time slot, based on a determined plurality of frame formats. In one example, the carrier frequency may be shifted using a mixer which is the same as multiplying with exp (j 2 pi f t).

In some examples, the in-line system 104 may shift a carrier frequency (CF) for the sampled signal. The shifted carrier frequency is agnostic to a frame format in the legacy signal.

In some examples, the in-line system 104 may synchronize a predetermined hopping bandwidth with the receiver side in-line system 104B. Further, the in-line system 104 may assign a set of keys for the predetermined hopping bandwidth based on a pre-determined hopping sequence and generate, a burst range and a frequency range corresponding to the hopping sequence based on the assigned set of keys and a burst duration of the in-line system. In some examples, a burst duration or a burst range may be a time required to send data and an overhead associated with a code block. When the burst ends, the frequency may hop to a different frequency. The frequency may hop within a range of desired or permitted bandwidth.

In some examples, the pre-determined hopping sequence (also referred herein as frequency hopping pseudo random sequence) may be generated using a shared key. The shared key may be a pseudo random number (for example, 256 bits) along with a National Security Agency (NSA) approved cryptographic algorithm (for example, AES-265 SHA-384). The shared key may be cryptographically generated. In some examples, the set of keys may also be a seed to the pseudo-random number generator.

In some examples, the pre-determined hopping sequence and a randomized keystream may be inputs into the frequency hopping synthesizer. The output of the frequency hopping synthesizer may include a randomized frequency hopping pattern at discrete time intervals.

In some examples, the in-line system 104 may synchronize the burst range and the frequency range corresponding to the hopping sequence by configuring a modified frequency range of the in-line system. In some examples, when the in-line system 104 adds a frequency hopping feature, the frequency may not change until the end of a current burst.

In some examples, the in-line system 104 may identify a plurality of burst boundaries associated with the legacy signal to initiate frequency hopping for the legacy signal, based on at least one of amplitude variations, phase shifts, and signal characteristics corresponding to variations. Further, the in-line system 104 may modify a carrier frequency (CF) for data transmission of the legacy signal, at each start of a burst in the identified plurality of burst boundaries. In some examples, a frequency translation may be performed with a mixer. A Numerically Controlled Oscillator (NCO) may be an example application of exp (j 2 pi f t). Specifically, the carrier frequency (CF) may be shifted by multiplication of exponential factor.

It should be appreciated that the communication network 100 and the in-line system(s) 104 depicted in FIG. 1 may be a few example implementations. Hence, the communication network 100 may or may not include additional features and some of the features described herein may be removed and/or modified without departing from the scope of the satellite communication network 100 outlined herein.

It should be appreciated that any number of customer-premise equipment (CPE) may be communicatively coupled to the terminals. In some examples, the customer premise equipment (CPE) may include any number of computing or mobile devices. For example, such a computing or mobile device may include, but is not limited to, a laptop, a tablet, a mobile phone, an appliance, a camera, a sensor, a thermostat, a vehicle, a display, and/or other interfaces. In general, the customer premise equipment (CPE) may include, without limitation, any number of network-enabled computing devices, elements, or systems. It should be appreciated that a network of such devices may be commonly referred to as “Internet of Things” (IoT). The CPE may be provided as a standalone, transport integrated, hybrid integrated, or fully integrated single device solution. In the standalone configuration, all WAN modems and accelerators are provided as standalone devices.

In another example, a point of presence (POP) or a network operation center (NOC) may be included in the satellite communication network 100. For example, the POP may be instantiated for load balancing and scaling to load. The location of the POP may be strategic to optimize transport modem characteristics such as latency, jitter, throughput, and/or network issues. The POP may include VPN firewalls to block unwanted intrusion or malicious software/connections. The POP may serve as an endpoint to additional VPN tunnels. Multiple VPN firewalls may be desired for scalability and load balancing. The POP may include one or more enterprise routers to route traffic between the accelerator gateway and the public internet. Routers may route traffic to private networks. Multiple routers may exist for scaling and load balancing.

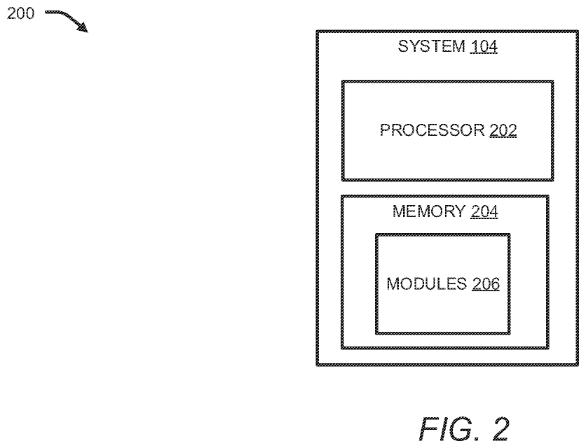

FIG. 2 illustrates an example block diagram 200 representation of an inline system 104, such as that shown in FIG. 1, capable of providing secure communication between modems 102, according to an example.

The in-line system 104 may include a processor 202, and a memory 204. The memory 204 may include processor-executable instructions, which on execution, cause the processor 202 to perform one or more operations described herein. The memory 204 may include one or more modules 206. The modules 206 may include, but are not limited to, a communication module, a signal reception module, a mode of operation determination module, a component configuration module, an action management module, a transmission module and/or other modules. Each of these modules, when executed by the processor 202 perform one or more functionalities described in the context of the in-line system 104. Execution of the machine-readable program instructions by the processor 202 may enable the in-line system 104 to perform one or more functions. The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processor 202 may include, for example, microprocessors, microcomputers, microcontrollers, digital signal processors, central processing units, state machines, logic circuits, and/or any devices that manipulate data or signals based on operational instructions. Among other capabilities, the processor 202 may fetch and execute computer-readable instructions from a memory (not shown) operationally coupled with in-line system 104 for performing tasks such as data processing, input/output processing, attributes extraction, and/or any other functions. Any reference to a task in the present disclosure may refer to an operation being, or that may be, performed on data or input information.

For example, the communication module may cause the processor 202 to establish a communication channel between the modem 102 and the in-line system 104 via a communication network. Further, the signal reception module may cause the processor 202 to receive the legacy signal from the modem 102, upon establishing the communication channel with the modem 102. The legacy signal comprises signal information, a channel requirement, and a modem configuration information. Further, the mode of operation determination module may cause the processor 202 to determine a type of mode of operation associated with the in-line system based on the received legacy signal and the channel requirement, wherein the type of mode of operation comprises direct sample processing with compression or decompression techniques, and encoder-modulator/demodulator-decoder or standalone modulator/demodulator functions, encryption/decryption, spreading/dispreading, and frequency hopping/frequency dehopping functions and the like.

Further, the component configuration module may cause the processor 202 to determine a plurality of configuration parameters associated with the plurality of configurable components of the in-line system 104 based on the determined type of mode of operation. Furthermore, the component configuration module may cause the processor 202 to configure the plurality of configurable components of the in-line system 104 at a real-time with the determined plurality of configuration parameters.

The action management module may cause the processor 202 to execute at least one action, in a sequence in each of the configured plurality of configurable components to process the received legacy signal. The at least one action is determined based on the determined plurality of configuration parameters and the mode of operation.

Further, the transmission module may cause the processor 202 to communicate the processed legacy signal to the external device via the established communication channel 106. The communication channel 106 comprises at least one of a random channel activity and a uniform channel activity associated with in-line system 104.

The interconnect (not shown in FIG. 2) may interconnect various subsystems, elements, and/or components of the in-line system 104. As shown, the interconnect may be an abstraction that may represent any one or more separate physical buses, point-to-point connections, or both, connected by appropriate bridges, adapters, or controllers. In some examples, the interconnect may include a system bus, a peripheral component interconnect (PCI) bus or PCI-Express bus, a Hyper Transport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect may allow data communication between the processor 202 and system memory 204, which may include read-only memory (ROM) or flash memory (neither shown), and random-access memory (RAM). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 202 may be the central processing unit (CPU) of the computing device and may control the overall operation of the computing device. In some examples, the processor 202 may accomplish this by executing software or firmware stored in system memory or other data via the storage. The processor 202 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter (not shown in FIG. 2) may connect to various multimedia elements or peripherals. These may include a device associated with visual (e.g., video card or display), audio (e.g., sound card or speakers), and/or various input/output interfaces (e.g., mouse, keyboard, touchscreen).

The network communicator (not shown) may provide the computing device with an ability to communicate with a variety of remove devices over a network and may include, for example, an Ethernet adapter, a Fiber Channel adapter, and/or another wired- or wireless-enabled adapter. The network communicator may provide a direct or indirect connection from one network element to another and facilitate communication between various network elements.

The storage (not shown) may connect to a standard computer-readable medium for storage and/or retrieval of information, such as a fixed disk drive (internal or external).

Many other devices, components, elements, or subsystems (not shown) may be connected in a similar manner to the interconnect or via a network. Code or computer-readable instructions to implement the dynamic approaches for payment gateway selection and payment transaction processing of the systems and methods may be stored in computer-readable storage media such as one or more of system memory or other storage. Code or computer-readable instructions to implement the dynamic approaches for payment gateway selection and payment transaction processing of the systems and methods may also be received via one or more interfaces and stored in memory. The operating system provided on computer system may be MS-DOS®, MS-WINDOWS®, OS/2®, OS X®, IOS®, ANDROID®, UNIX®, Linux®, or another operating system.

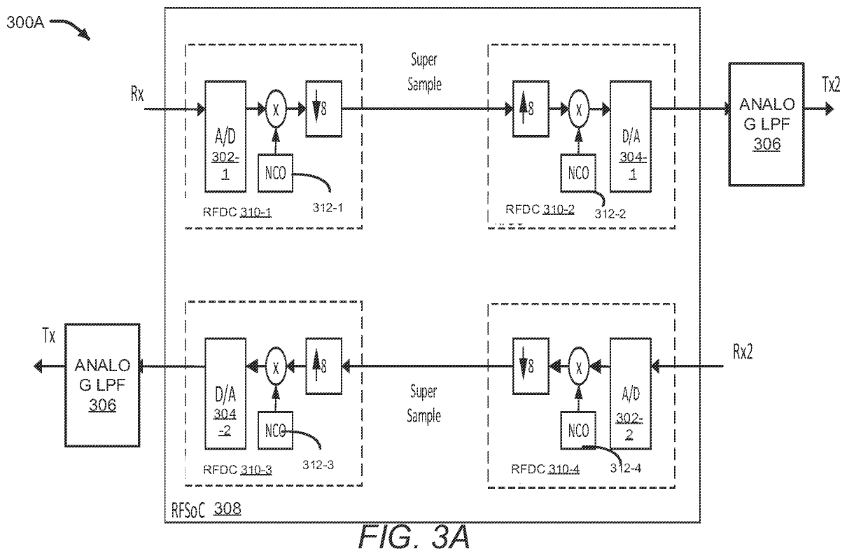

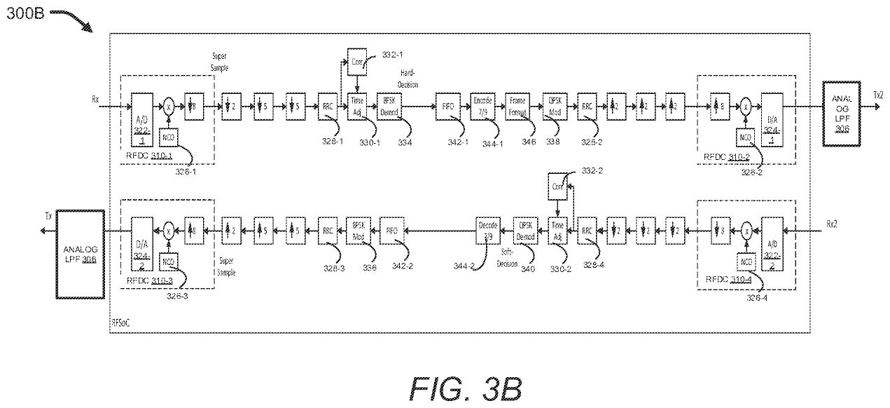

FIG. 3A-B illustrates an example block diagram representation of a system, such as that shown in FIG. 1, depicting detailed view of internal components within the system, according to an example. FIG. 3A depicts an example system 300A similar to the in-line system 104 as shown in FIG. 1. The system 300A may include an analog to digital converter (A/D) 302-1, 302-2, a digital to analog converter (D/A) 304-1, 304-2, an analog low pass filter (LPF) 306, which may be included in a radio frequency system on chip (RFSoC) 308, and a Numerically Controlled Oscillator (NCO) 312-1, 312-2, 312-3, and 312-4. The A/D 302, D/A 304, and the NCO 312 may form a Radio Frequency Digital Converter (RFDC) 310-1, 310-2, 310-3, and 310-4 (herein after referred to as RFDC 310).

The RFDC 310 may convert analog radio frequency signals to digital form (A/D-Analog to Digital) and vice versa (D/A-Digital to Analog). The A/D 302, and D/A 304 may convert analog signals into digital data, and may convert digital data back into analog signals, respectively. Further, the NCO 312 may be used in signal processing for generating and manipulating frequencies. Further, the component which includes down arrow 8 and up arrow 8 may be a control signals or parameters for adjusting or controlling the RFDC 310 or NCO 312 settings, for down sampling, and up sampling, respectively. The super sample may be obtained from the down sampling component. Further, the analog LPF 306 may filter out high-frequency noise or unwanted signals from the analog signal.

In an example, the modem 102A may be communicatively coupled to the system 300A. As the legacy signal occurs, it arrives at the receiver on a top line of the system 300A. At this point, the system 300A may include the option to sample the received legacy signal, and then proceed directly to the digital-to-analog conversion (D to A) process. Subsequently, the system 300A may transmit out without any significant alterations. This process may involve sampling and immediate transmission over the airwaves. If the original modem is functioning as expected, introducing a legacy in-line system, such as a transmitter side in-line system 104A or the system 300A may not interfere with the operation of the modem 102A or 102B. The modem 102A or 102B may continue to function without any interruption. The bottom line follows a similar pattern, with signals arriving via the airwaves, undergoing analog-to-digital (A to D) conversion, being sampled, and then introduced to the D to A conversion process before being transmitting out.

For example, the system 300A may function as a wire, however, the system 300A introduces the concepts of analog-to-digital (A to D) and digital-to-analog (D to A) conversion, and this symmetry exists in both the top and bottom paths within the system 300A. Both the paths in system 300A may primarily serve as pass-through channels, facilitating the flow of signals.

FIG. 3B depicts a system 300B for providing secure communication between modems. The system 300B includes an analog to digital (A/D) converter 322-1, and 322-2, digital to analog converter (D/A) 324-1, and 324-2, a numerically controlled oscillator (NCO) 326-1, 326-2, 326-3, and 326-4, a root raised cosine (RRC) component 328-1, 328-2, 328-3, and 328-4, a time adjustment component 330-1, and 330-2, a correlator 332-1, and 332-2, a 8 phase shift keying (8PSK) demodulation component 334, 8PSK modulation 336, quadrature phase shift keying (QPSK) modulation 338, QPSK demodulation 340, first in first out (FIFO) component 342-1, and 342-2, an encode 7/9 component 344-1, a decode 7/9 component 344-2, and a frame format component 346.

The RRC 328 may be a digital filter for pulse shaping and channel filtering. The time adjustment component 330 may adjust the timing of signals to synchronize the signal. Further, the correlator 332 may be a device or algorithm used to measure the similarity or correlation between two signals, for example, signal detection and synchronization. In addition, the 8PSK demodulation component 334 may demodulation technique used for 8-Phase Shift Keying (8PSK) modulation, a digital modulation scheme where eight different phase angles are used to represent digital data. Further, the 8PSK demodulation component 334 may output a hard decision, which is a decision-making process in which received symbols are mapped directly to the nearest constellation point without considering the probability of errors. The FIFO component 342 may include a data structure that organizes data in a way that the first data item added is the first to be removed. Furthermore, the encode 7/9 344-1 may include a specific error-correcting code, with 7 bits of data and 9 bits in total (7 data bits and 2 parity bits), used for error detection and correction. The frame format component 346 may be a structure and an arrangement of data in a communication frame, which may include information such as headers, payload data, and error-checking codes. The QPSK modulation 338 may be a digital modulation scheme that uses four phase shifts to represent digital data.

The in-line system 104 may include a plurality of modes of operation. For example, one mode of operation may include sampling, where various manipulations may be introduced. At the receiver end, acquisition processes such as correlators and RRC timing adjustments may be applied to acquire the legacy signal. Demodulation levels may then be performed to recover the original data down to the symbol level. Subsequently, the data may be re-encoded, modulated, and sent out via the D/A converter 324. In the top path, the sampled data from the A/D 322 may either be sent out directly without further processing or undergo additional manipulations. In the top path, the legacy signal may be demodulated. Furthermore, an encryption may be applied in the top path, offering enhanced security features. Similarly, in the bottom path, the incoming data undergoes acquisition, demodulation, and subsequent remodulation before being transmitted out again. These processing methods may disclose diverse ways of handling modems 102 for over-the-air transmission.

In this scenario, the output of the A to D converter 322 may be utilized. Instead of demodulating and decoding the data from the modem 102, the raw samples may be taken from the A to D converter 322. These samples may be further encoded, modulated, and transmitted. This approach allows the in-line system 104 to remain agnostic to the specifics of the modem 102. The choice between these models depends on the specific use case.

For instance, in situations where the original legacy waveform is required without any alterations, a simple pass-through model may be employed. In this case, the in-line system 104 acts as a conduit, sampling the data and transmitting the data without modification. Alternatively, when a more complex transformation may be needed, demodulation, decoding, and subsequent encoding and modulation may be applied. The in-line system 104 converts analog signals into the digital domain. Once in the digital domain, the data may be manipulable. The compressor may use different techniques to manage bandwidth requirements. The compression may occur before encryption and modulation, reducing the size of the data set that needs to be transmitted.

Additionally, burst detection mechanisms may be integrated. The power levels and sequences from the legacy transmission may be used to establish transmission of the bursts. The in-line system 104 such as the system 300A and 300B may include the ability to adapt to various modulation, encoding, and encryption techniques. The in-line system 104 may operate independently of the modems 102, to be a versatile approach for various communication scenarios.

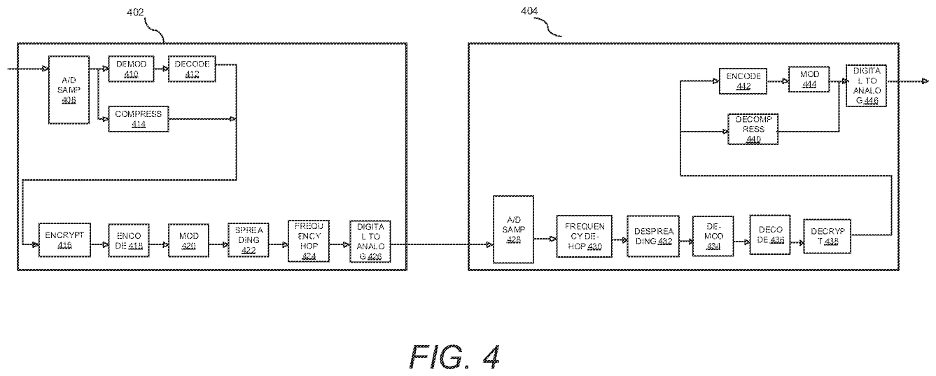

FIG. 4 illustrates an example block diagram representation of a transmitter side in-line system 104A and a receiver side in-line system 104B, according to an example. At the transmitter side 402, the transmitter side in-line system 104A may include an analog to digital converter 408, a demodulation module 410, a decoder module 412, a compressor module 414, an encryption module 416, an encoder module 418, a modulator module 420, a spreading module 422, a frequency hopping module 424, and a digital to analog (D/A) conversion module 426.

The analog to digital (A/D) converter 408 receives the legacy signal from the modem 102A. The A/D converter 408 transforms the legacy signal into a digital format, enabling precise digital processing of the legacy signal.

The demodulation module 410 and the decoder module 412 are configured to reverse the modulation and encoding applied to the legacy signal at the transmitter side, restoring the signal into its original form.

The compressor module 414 allows for the reduction of data size through compression techniques. The encryption module 416 is configured to employ, for example, a cryptographic technique to secure the data within the legacy signal. In some examples, the encryption techniques such as for example, but not limited to, Advanced Encryption Standard (AES) block encryptor, a stream encryptor, a quantum encryptor, a commercial solution for classified program (CSfc) encryptor and the like.

The encoding module 418 is configured to apply encoding algorithms to further optimize data representation for efficient transmission. The modulator module 420 applies modulation techniques to prepare the data for transmission over the communication channel. The spreading module 422 is configured to spread the legacy signal across a wider bandwidth, enhancing resistance against interference and providing improved reception. The frequency hopping module 424 is configured to perform dynamic changes in the carrier frequency of the legacy signal during transmission, enhancing security and resistance against interception. In an example, the frequency hopping module 424 is configured to perform frequency hopping at specific boundaries, such as burst intervals within the modem 102 transmission. By implementing frequency hopping at these intervals, the frequency hopping module 424 is configured to perform dynamic changes in carrier frequencies without requiring intricate knowledge of modem frame formats such as burst or slot times.

The in-line system 104 may convert modulation and coding parameters into discrete samples. These samples, typically represented as 10 or 6-bit numbers, are transmitted to analog devices.

The D/A conversion module 426 transforms the processed digital signal back into analog format for transmission.

The transmitter side in-line system 104A provides flexibility in choosing between modem operations and direct sample processing. Additionally, the transmitter side in-line system 104A allows for the combination of encoder-modulator/demodulator-decoder or modulator/demodulator functions, enhancing versatility. The transmitter side in-line system 104A allows customization options for data processing of the legacy signal by providing optional modules for encryption/decryption, spreading/dispreading, and frequency hopping/frequency de-hopping. The optional modules may be individually or jointly added to the data path.

In an example, the customization options may include selecting either to perform the modem blocks or to operate on direct samples such as with some compression and decompression techniques. Furthermore, the encoder-modulator/demod-decoder or the modulator/demod may be used together. Optionally, the encrypt/decrypt, the spreading/dispreading, and the frequency hopping/frequency de-hopping may be individually or in combination be added to the data path for processing the legacy signal.

At the receiver side 404, the receiver side in-line system 104B may include an analog to digital converter 428, a frequency de-hopping module 430, a de-spreading module 432, a demodulation module 434, a decoding module 436, a decryption module 438, an un-compress module 440, an encoding module 442, a modulation module 444, and a digital to analog converter module 446.

The receiver side in-line system 104B reverses the operations performed at the transmitter side 402 using the above-mentioned modules. Further, the receiver side in-line system 104B forwards the received legacy signal in analog form to the modem 102B.

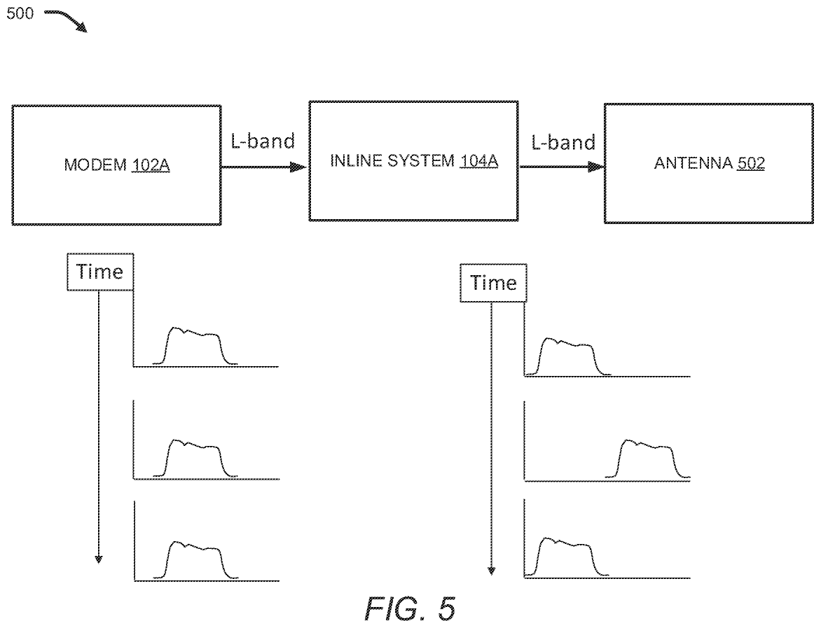

FIG. 5 illustrates an example flow diagram 500 representation depicting interactions between a modem 102, an in-line system 104 and an antenna 502, according to an example. In an example, the in-line system 104 may act as an in-line hopping device. In the preferred example, the in-line system 104 may operate in either an analog hopping mode or a digital hopping mode.

In the analog hopping mode, the in-line system 104 determines a hop activation criterion for the legacy signal. The hop activation criteria may indicate that a hopping is implemented when no burst associated with legacy signal is currently active. This ensures that the hopping process does not interfere with ongoing transmissions. In an example, the hop activation criteria may also include a hopping mechanism which applies hopping to entire bursts of the legacy signal, ensuring that the transition from one frequency to another occurs seamlessly across the entire burst duration, including factors such as roll off and inter-burst gaps. The hop duration may be an integer multiple of burst duration (including roll off and inter-burst gaps). This ensures that the hopping process aligns harmoniously with the burst structure.

In an example, both transmitters and receivers are furnished with hopping keys and a mathematical derivation algorithm that dictates the next hop. The in-line system 104 is equipped with the capability to store and implement hopping keys and the mathematical derivation algorithm. This enables modems 102 to seamlessly incorporate hopping mechanisms.

In some examples, the mathematical derivation algorithm to generate control bits may be dependent on the keys and a system Time of Day (TOD). The control bits which form the keys may change infrequently (typically in the order of once a day) while the TOD bits used (derived from the TOD) may change frequently (in the order of nanoseconds). As a result, the output of the code generator may be a time varying stream of control bits which when fed into the frequency synthesizer may generate randomized carrier frequencies within hopping bandwidth. The hopping bandwidth is a configuration parameter for the in-line system 104. The operators may also define ‘stay out’ (notched filters) areas within the hopping bandwidth that are under persistent interference. The frequency synthesizer algorithms attempt to uniformly distribute the carrier frequencies over the hopping bandwidth, over a time span.

In some examples, the mathematical derivation algorithm may be a pseudo-random number generator such as that of a linear-feedback-shift-register polynomial or Mersenne Twister, or the like.

At the transmitter side, Frequency Adjustment at Burst Start (N): at the initiation of burst N, the in-line system 104 adjusts the carrier frequency (CF) from f1 to f2, aligning it with the hopping sequence. The frequency adjustment at burst start (N+M) may include, at the commencement of burst N+M, adjusting the CF from f1 to f3, following the hopping sequence by the in-line system 104.

At the Receiver side: A frequency adjustment at burst start (N): The in-line system 104 adjusts its CF at the initiation of burst N, transitioning from f2 to f1, aligning with the transmitter's hopping sequence. The frequency adjustment at burst start (N+M) may include, at the commencement of burst N+M, adjusting its CF from f3 to f1, maintaining synchronization with the hopping sequence by the in-line system 104. In this example, the in-line system 104 ensures that hopping occurs seamlessly, aligning with the burst structure and enhancing the security and efficiency of data transmission in modem 102-based communication systems.

In the digital hopping mode, the in-line system 104 uses a digital hopping technique onto the legacy signal. Unlike the analog hopping mode which involves shifting the carrier frequency, the in-line digital hopping technique operates by digitally shifting the frequency of samples (digital bits). This eliminates the need for analog carrier shifts and introduces a more flexible and efficient hopping process. The in-line system 104 may be designed to efficiently sample the transmission and obtain the In-Phase (I) and Quadrature (Q) samples of the legacy signal. These samples are then processed to facilitate digital hopping. These samples (digital bits) are frequency shifted instead of analog shift of the carrier. Further, the in-line system 104 may transmit the I/Q samples by performing an in-line D/A on a different center frequency. Specifically, the I/Q samples are subjected to a D/A conversion on a different center frequency, effectively shifting the transmission to a new frequency range. For instance, a transmission with a data rate of 800 bits per second (bps) can be transformed into a higher bandwidth transmission with improved spectral efficiency. As an illustration, a transmission with a data rate of 800 bps and utilizing Binary Phase Shift Keying (BPSK) modulation with a bandwidth of 1 kHz can be sampled at 2.5 kHz, with each sample represented by 6 bits. This results in an effective data rate of approximately 15 kbps. Applying a 50% Lempel-Ziv-Welch (LZW) compression further reduces the data rate to approximately 8 kbps. Finally, the transmission may upconvert to a center frequency of 10 KHz.

In an example, the in-line system 104 operates independently of transmission details, including, such as but not limited to, constellation parameters, amplitude, phase, bit definition, burst format, burst boundary of the source signal and the like. This allows for seamless integration of the in-line system 104 into diverse communication systems without the need for extensive reconfiguration.

Further, the in-line system 104 autonomously identifies burst boundaries, enabling efficient sampling and hopping within a prior non-hopping waveform. Specifically, the in-line system 104 independently determines the burst boundary and samples the legacy signal and introduces hopping in a prior non-hopping waveform. In an example, digital hopping also allows hopping within a burst. Further, the in-line system 104 may be waveform independent. Furthermore, the in-line system 104 potentially may hop across beams, satellites that conventional system was not designed to achieve (for example, adjusting transmit power when trying to hop onto another beam/satellite). This includes adjustments in transmit power to facilitate hopping onto another beam or satellite.

In an example, the in-line system 104 performs hop synchronization to optimize data transmission in communication system. In an example, the two hop synchronization methods may include a seed hopping polynomial method and a carrier sense/detection of the five appropriate channels method, which includes transmitting sequentially (hopping) the processed signals along the five appropriate channels.

In the seed hopping polynomial method, hop synchronization is achieved using a seed hopping polynomial. This polynomial serves as the basis for determining the hop sequence, providing a structured approach to frequency hopping. In the carrier sense or detection of five appropriate channels method involves carrier sense or detection of the five appropriate channels for transmission. The transmitter then sequentially transmits data on these channels, effectively implementing frequency hopping. The carrier sense or detection of five best channels method involves sub-options such as for example, but not limited to, an erasure coding for recovery. In this sub-option, the transmission is encoded using erasure coding, allowing for recovery at the receiver. This method enhances data integrity and resilience against errors. Erasure coding capability added to the in-line system 104 provide jamming resistance and recovery by adding advanced coding technique to mitigate jamming without spreading or hopping. In some examples, an erasure code may allow part of a transmission code block to be corrupted. However, such code block may still be completely reconstructed if a sufficient portion of the code block is received uncorrupted. In such scenarios, a threshold is code dependent. The erasure code may be based on a low-density parity check code for a binary symmetric channel. In this case, if a jamming signal covers less than the threshold of the erasure code correction capability, the entire transmission may be recovered despite some of the information being jammed or corrupted. In some examples, the erasure code may be a low-density parity check (LDPC) code and a reed-Solomon codes.

In an example, the transmitter side in-line system 104A receives a modulated/encoded signal from the modem 102A. The transmitter side in-line system 104A is programmed with information on frequency and bandwidth comprising the carrier. Further, the transmitter side in-line system 104A hops the carrier to another center frequency based on a pre-configured hopping pattern. Furthermore, the transmitter side in-line system 104A injects a random data in other parts of the spectrum associated with the legacy signal.

In an example, the receiver side in line system 104B receives a signal from the antenna. Further, the receiver side in line system 104B is programmed with information on bandwidth and hopping pattern of the legacy signal. Further, the receiver side in line system 104B adjusts filter to extract the hopped signal. Further, the receiver side in line system 104B sends the hopped signal to modem 102B.

In an example, the in-line system 104 may be prototyped on for example, but not limited to, a general purpose System on Chip (SoC) or a Field-Programmable Gate Array (FPGA) card. To perform frequency hopping, the in-line system 104 may use for example, but not limited to, a Field-Programmable Gate Array (FPGA) system. Further, the synchronization of hopping sequence between sender or receiver may be achieved by using for example, but not limited to, a global positioning system (GPS) receiver. Alternatively, the synchronization of hopping sequence between sender or receiver may be achieved by using an external signal (out route or spread signal or PTP). In yet alternate example, the synchronization of hopping sequence between sender or receiver may be achieved by an in-band signal or notification indicating to activate a switch, where the in-band signal or notification is sent from the transmitter side in-line system 104A to the receiver side in-line system 104B.

In an example, the frequency hopping may be achieved in digital domain by a sampling rate which is two to three times greater than an input frequency for a band limited signal.

In some examples, the in-line system 104 may be configured with an additional overlay or underlay channel. Such additional overlay or underlay channel may be added at the transmitter. At the receiver side, such additional overlay or underlay channel may be extracted with cancelled residual which may then be forwarded to the primary receiver. Further, the in-line system 104 may perform spreading to achieve energy per chip to noise spectral density of −30 dB or lower in spreading in order to improve signal quality and network performance. In an example, hopping boundary may occur at burst boundaries. In order to detect boundaries at transmitter side, the in-line system 104 may receive the boundaries from the modulation module or from the transmitter power detector module. In an example, the burst start of the legacy signal is indicated to the in-line system 104 by the modem.

In an example, the in-line system 104 may be configured to enhance transmission security through a unique series of signal transformations. By employing methods such as for example, but not limited to, signal sampling, XOR operations with pseudo-random numbers, bandwidth modulation, data compression, and encryption, the in-line system 104 achieves improved data security during transmission.

In an example, the in-line system 104 may be configured to sample the transmitted signal and capture in-phase (I) and quadrature (Q) samples. Further, the I/Q samples are then subject to an XOR operation with a pseudo-random number generator (PRNG) output. This operation introduces an element of randomness and obfuscation into the transmitted signal, thereby preventing interception and deciphering of data by unauthorized parties.

In an example, the in-line system 104 may be configured to vary the bandwidth. Specifically, changing the modulation and coding rate (MODCOD) from QPSK 4/9 to 16APSK 1/9 would double the bandwidth for the same data rate. The new MODCOD ensures that the signal occupies a wider frequency spectrum, further complicating eavesdropping attempts.

In an example, the in-line system 104 may be configured to adjust the sample rate (1 kHz to 2.5 kHz Samples). Specifically, the signal is then subjected to a sample rate adjustment, increasing it from 1 kHz to 2.5 kHz samples. This higher sample rate allows for finer resolution of the signal and enhances its security.

In an example, the in-line system 104 may be configured to compress the data. To optimize transmission efficiency, the signal is subjected to data compression using a compression algorithm. This reduces the required bandwidth to carry digitized samples.

In an example, the in-line system 104 may be configured to XOR with Random Number. Further enhancing security, the compressed signal is XORed with a randomly generated number. This introduces an additional layer of encryption to the data, making it even more challenging to decipher.

In an example, the in-line system 104 may be configured to adjust a final bandwidth (8 kbps to 10 khz). Specifically, the signal's bandwidth is adjusted one more time, increasing it from 8 kbps to 10 kHz. This transformation ensures that the transmitted signal occupies a broader frequency spectrum.

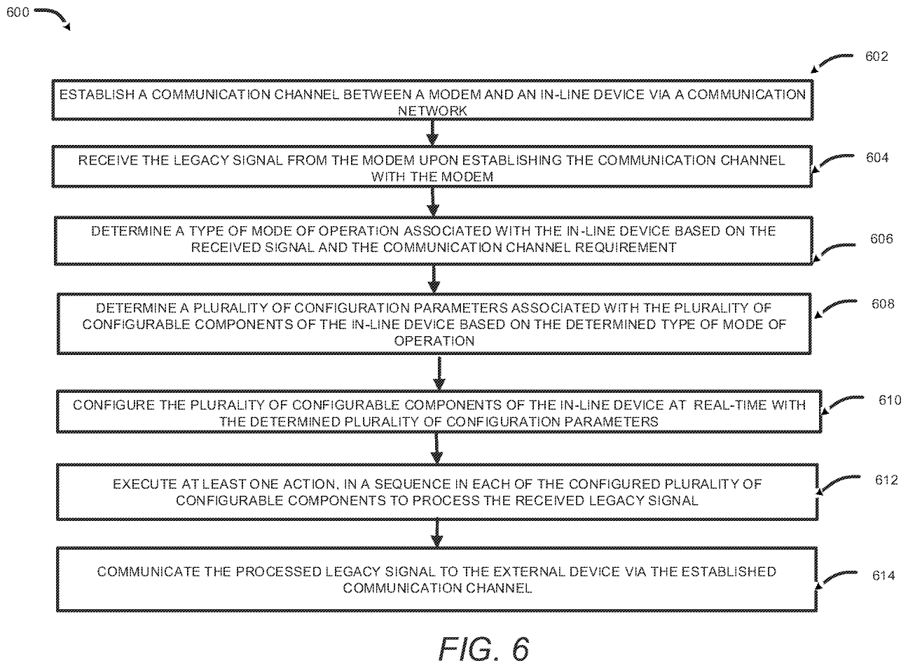

FIG. 6 illustrates an example flow diagram representation of a method 600 for providing secure communication between modems 102, according to an example. The disclosed method 600 may be performed by one or more components of the in-line system 104 disclosed herein. For example, with reference to FIG. 2, the steps disclosed herein may be performed by the processor 202.

At block 602, the method 600 may include establishing, by a processor 202, a communication channel between a modem 102 and an in-line system 104 via a communication network.

At block 604, the method 600 may include receiving, by the processor 202, a legacy signal from the modem 102, upon establishing the communication channel with the modem 102. The legacy signal comprises signal information, a channel requirement, and a modem configuration information.

At block 606, method 600 may include determining, by the processor 202, a type of mode of operation associated with the in-line system 104 based on the received legacy signal and a channel requirement. The type of mode of operation comprises direct sample processing with compression or decompression techniques, encoder-modulator/demodulator-decoder or standalone modulator/demodulator functions, encryption/decryption, spreading/dispreading, and frequency hopping/frequency de-hopping and the like.

At block 608, the method 600 may include determining, by the processor 202, configuration parameters associated with the plurality of configurable components of the in-line system 104 based on the determined type of mode of operation.

At block 610, the method 600 may include configuring, by the processor 202, a plurality of configurable components of the in-line system 104 at a real-time with the determined plurality of configuration parameters.

At block 612, the method 600 may include executing, by the processor 202, in a sequence in each of the configured plurality of configurable components to process the received legacy signal. The at least one action is determined based on the determined plurality of configuration parameters and the mode of operation.

At block 614, the method 600 may include communicating, by the processor 202, the processed legacy signal, via a communication channel 106 to the external device. The communication channel comprises at least one of a random channel activity and a uniform channel activity associated with an in-line system 104.

The order in which the method 600 is described is not intended to be construed as a limitation, and any number of the described method blocks may be combined or otherwise performed in any order to implement the method 600 or an alternate method. Additionally, individual blocks may be deleted from the method 600 without departing from the spirit and scope of the ongoing description. Furthermore, the method 600 may be implemented in any suitable hardware, software, firmware, or a combination thereof, that exists in the related art or that is later developed. The method 600 describes, without limitation, the implementation of the in-line system 104. A person of skill in the art will understand that method 600 may be modified appropriately for implementation in various manners without departing from the scope and spirit of the ongoing description.

Various examples of systems and methods for securing communications between modems 102 may be provided. Various example implementations of the disclosed approach herein may provide systems and methods for incorporating an in-line system 104 as an extension to the modems 102. The in-line system 104 provides flexibility in choosing between modem operations and direct sample processing. Additionally, the in-line system 104 allows for the combination of encoder-modulator/demodulator-decoder or modulator/demodulator functions, enhancing versatility. Optional modules for encryption/decryption, spreading/dispreading, and frequency hopping/frequency dehopping may be individually or jointly added to the data path, providing further customization options for data processing.

The present disclosure provides an adaptive TRANSEC method and system for SCPC communication channels, with provisions for future expansion into other channel types. By incorporating encryption, channel activity management, and optional mutual authentication, the present in-line system 104 secures communication channels against unauthorized access, traffic analysis, and potential breaches. The adaptive nature of this system ensures that security parameters dynamically adapt to evolving threat landscapes, maintaining appropriate security levels at all times. Further, the present in-line system 104 actively manages channel activity to present a seemingly random or uniformly distributed pattern, effectively eliminating any noticeable regularities. This deliberate concealment of activity patterns acts as a deterrent against traffic analysis attempts.

The present disclosures introduce a method and system for seamlessly coupling legacy and modern communication devices by digitally representing essential transmission parameters. By reducing the legacy information requirement to a digitized format that incorporates key characteristics such as amplitude, phase, and bit definitions, the present disclosure enables newer devices to operate in conjunction with older counterparts. This coupling is achieved through an in-line implementation, a critical aspect that ensures compatibility without requiring modification of existing hardware. The in-line system 104 is entirely waveform independent. This means that the in-line system 104 may adapt to various waveform characteristics without requiring extensive reconfiguration. This feature significantly enhances the versatility and applicability of the present disclosure across different communication environments.

The present disclosure addresses the challenge of efficiently sampling analog signals in legacy and modern communication devices while managing the required bandwidth. The present system introduces an advanced digital sampling and bandwidth management system that significantly simplifies the process of data acquisition, reduces bandwidth waste, and ensures appropriate interoperability between different communication technologies.

The present disclosure provides an advanced digital sampling approach. When analog signals are sampled, the present system takes care of key signal attributes, such as amplitude, phase shifts, and the rate of amplitude change. These attributes are captured in the digitization process. This means that the need for an intricate understanding of modulation, burst boundaries, or other signal-specific details are eliminated. Through the digitization process, the present system reduces the information requirement to a fundamental level, enabling the present system to work with the digital representation of the signal characteristics. This obviates the need to have in-depth knowledge of signal modulation schemes and eliminates the requirement for precise burst boundary detection.

While the present system may manage without detailed information, for specific cases, it may still require knowledge of the center carrier frequency that the modem 102 intends to transmit. In such instances, the present system may either receive this information directly or employ advanced techniques such as for example, but not limited to, a Fast Fourier Transform (FFT) to detect the carrier's location within the spectrum. This detection aids in precise digitization of the signal.

To further optimize the sampling process, the present disclosure provides the capability to adapt the sampling rate and bandwidth to the specific needs/requirement of the communication channel. By using this adaptive approach, the present system may reduce the required bandwidth. The present system efficiently manages the trade-off between the information known about the signal and the necessary sampling rate, ensuring that bandwidth is used judiciously.

The present system allows users to select a particular channel or spectrum of interest within a broader bandwidth. This means that there is no necessity to sample the entire bandwidth unnecessarily. Instead, the present system may focus on the specific channel, optimizing bandwidth utilization. One of ordinary skill in the art will appreciate that techniques consistent with the ongoing description are applicable in other contexts as well without departing from the scope of the ongoing description.

As mentioned above, what is shown and described with respect to the systems and methods above are illustrative. While examples described herein are directed to configurations as shown, it should be appreciated that any of the components described or mentioned herein may be altered, changed, replaced, or modified, in size, shape, and numbers, or material, depending on application or use case, and adjusted for managing network communication.

It should also be appreciated that the systems and methods, as described herein, may also include, or communicate with other components not shown. For example, these may include external processors, counters, analyzers, computing devices, and other measuring devices or systems. This may also include middleware (not shown) as well. The middleware may include software hosted by one or more servers or devices. Furthermore, it should be appreciated that some of the middleware or servers may or may not be needed to achieve functionality. Other types of servers, middleware, systems, platforms, and applications not shown may also be provided at the back end to facilitate the features and functionalities of the testing and measurement system.

Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

Although examples are directed to satellite communication systems, such as high throughput satellite (HTS) systems, it should be appreciated that the systems and methods described herein may also be used in other various systems and other implementations. For example, these may include other various telecommunication tests and measurement systems. In fact, there may be numerous applications in cable or optical communication networks, not to mention fiber sensor systems that could employ the systems and methods as well.

What has been described and illustrated herein are examples of the implementation along with some variations. The terms, descriptions, and figures used herein are set forth by way of illustration and are not meant as limitations. Many variations are possible within the scope of the implementations, which are intended to be defined by the following claims—and their equivalents—in which all terms are meant in their broadest reasonable sense unless otherwise indicated.

1. A system comprising:
a modem to communicate a legacy signal with an external device, wherein the legacy signal comprises at least one of an analog signal and a digital signal;
an in-line system, communicatively connected with the modem and the external device, wherein the in-line system comprises:
a plurality of configurable components;
a processor; and
a memory coupled to the processor, wherein the memory comprises processor-executable instructions, which on execution, cause the processor to:
establish a communication channel with the modem via a communication network;
receive the legacy signal from the modem upon establishing the communication channel with the modem, wherein the legacy signal comprises a signal information, a channel requirement, and a modem configuration information;
determine a type of mode of operation associated with the in-line system based on the received legacy signal and the channel requirement;
determine a plurality of configuration parameters associated with the plurality of configurable components of the in-line system based on the determined type of mode of operation;
configure the plurality of configurable components of the in-line system at real-time with the determined plurality of configuration parameters;
execute at least one action, in a sequence in each of the configured plurality of configurable components to process the received legacy signal, wherein the at least one action is determined based on the determined plurality of configuration parameters and a mode of operation; and
communicate the processed legacy signal to the external device via the established communication channel, wherein the established communication channel comprises at least one of a random channel activity and a uniform channel activity associated with the in-line system.

2. The system of claim 1, wherein the at least one action comprises:
sampling the legacy signal from the analog signal to the digital signal, to output a sampled signal corresponding to the legacy signal;
determining at least one of a legacy signal recovery action and a compression to be performed on the sampled signal, wherein the legacy signal recovery action comprises a demodulating action and a decoding action;
extracting the signal information from the sampled signal by performing at least one of the legacy signal recovery action and the compression, based on the determination, wherein the signal information comprises a plurality of symbols;
encrypting the signal information of the sampled signal, based on the at least one of the legacy signal recovery action and the compression performed;
ingesting the encrypted signal information onto the established communication channel by encoding and modulating the encrypted signal information using a modulating scheme;
classifying the modulated signal information into a plurality of symbols based on content of modulated signal information;
modifying a transmission frequency associated with the legacy signal over a time interval by performing frequency hopping on the plurality of symbols; and
generating a re-sampled signal corresponding to the legacy signal based on the modified transmission frequency, wherein the re-sampled signal comprises frequency hopped symbols.

3. The system of claim 1, wherein, the at least one action comprises:
sampling a re-sampled signal from the analog signal to the digital signal, to output a sampled signal corresponding to the legacy signal;
modifying a transmission frequency associated with the sampled signal over a time interval by performing frequency de-hopping of a spread symbols associated with the sampled signal;
de-classifying frequency de-hopped spread symbols into a plurality of symbols to output de-spread symbols;
demodulating and decoding the de-spread symbols into the signal information of the legacy signal;
determining at least one of a legacy signal generation action and a decompression to be performed based on the signal information, wherein the legacy signal generation action comprises a modulating action and an encoding action and wherein the signal information is in a decrypted form;
performing at least one of the legacy signal generation action and the decompression on the legacy signal based on the determination; and
outputting the legacy signal by re-sampling the sampled signal comprising decrypted signal information from the digital signal to the analog signal.

4. The system of claim 1, wherein the processor is to:
determine a plurality of frame formats associated with the legacy signal, wherein the plurality of frame formats comprises at least one of a time slot and a burst code block, wherein the time slot corresponds to specific time intervals for a data transmission; and
shift a carrier frequency (CF) within the time slot, based on determined plurality of frame formats.

5. The system of claim 2, wherein the processor is to:
shift a carrier frequency (CF) for the sampled signal, wherein the shifted carrier frequency is agnostic to a frame format in the legacy signal.

6. The system of claim 1, wherein the processor is to:
synchronize a predetermined hopping bandwidth with the in-line system;
assign a set of keys for the predetermined hopping bandwidth based on a pre-determined hopping sequence; and
generate, a burst range and a frequency range corresponding to the pre-determined hopping sequence based on the assigned set of keys and a burst duration of the in-line system.

7. The system of claim 6, wherein the processor is to:
synchronize the burst range and the frequency range corresponding to the pre-determined hopping sequence by configuring a modified frequency range of the in-line system.

8. The system of claim 1, wherein the processor is to:
identify a plurality of burst boundaries associated with the legacy signal to initiate frequency hopping for the legacy signal, based on at least one of amplitude variations, phase shifts, and signal characteristics corresponding to variations; and
modify a carrier frequency (CF) for data transmission of the legacy signal, at each start of a burst in the identified plurality of burst boundaries.

9. The system of claim 1, wherein the plurality of configuration parameters of the received legacy signal comprises at least one of a symbol timing, a burst timing, a frequency offset, a phase offset, a UW(s), a modulation/demodulation scheme, a center frequency, a symbol rate, a reception forward error correction rate (FEC), a reception roll off, and a reception signal power.

10. A method comprising:
establishing, by a processor, a communication channel between a modem and an in-line system via a communication network;
receiving, by the processor, a legacy signal from the modem, upon establishing the communication channel with the modem, wherein the legacy signal comprises a signal information, a channel requirement, and a modem configuration information;
determining, by the processor, a type of mode of operation associated with the in-line system based on the received legacy signal and the channel requirement;
determining, by the processor, a plurality of configuration parameters associated with a plurality of configurable components of the in-line system based on the determined type of mode of operation;
configuring, by the processor, a plurality of configurable components of the in-line system at real-time with the determined plurality of configuration parameters;
executing, by the processor, at least one action in a sequence in each of the configured plurality of configurable components to process the received legacy signal, wherein the at least one action is determined based on the determined plurality of configuration parameters and a mode of operation; and
communicating, by the processor, the processed legacy signal to an external device via the established communication channel, wherein the established communication channel comprises at least one of a random channel activity and a uniform channel activity associated with the in-line system.

11. The method of claim 10, wherein the at least one action comprises:
sampling, by the processor, the legacy signal from an analog signal to a digital signal, to output a sampled signal corresponding to the legacy signal;
determining, by the processor, at least one of a legacy signal recovery action and a compression to be performed on the sampled signal, wherein the legacy signal recovery action comprises a demodulating action and a decoding action;
extracting, by the processor, the signal information from the sampled signal by performing at least one of the legacy signal recovery action and the compression, based on the determination, wherein the signal information comprises a plurality of symbols;
encrypting, by the processor, the signal information, based on performed at least one of the legacy signal recovery action and the compression;
ingesting, by the processor, the encrypted signal information onto the established communication channel by encoding and modulating the encrypted signal information using a modulation scheme;
classifying, by the processor, the modulated signal information into a plurality of symbols based on content of modulated signal information;
modifying, by the processor, a transmission frequency associated with the legacy signal over a time interval by performing a frequency hopping on the plurality of symbols; and
generating, by the processor, a re-sampled signal corresponding to the legacy signal based on the modified transmission frequency, wherein the re-sampled signal comprises a frequency hopped symbols.

12. The method of claim 10, wherein, the at least one action comprises:
sampling, by the processor, a re-sampled signal from an analog signal to a digital signal, to output a sampled signal corresponding to the legacy signal;
modifying, by the processor, a transmission frequency associated with the sampled signal over a time interval by performing a frequency de-hopping of a spread symbols associated with the sampled signal;
de-classifying, by the processor, frequency de-hopped spread symbols into a plurality of symbols to output de-spread symbols;
demodulating and decoding, by the processor, the de-spread symbols into a signal information;
determining, by the processor, at least one of a legacy signal generation action and a decompression to be performed based on a decrypted signal information, wherein the legacy signal generation action comprises a modulating action and an encoding action;
performing, by the processor, at least one of the legacy signal generation action and the decompression, based on the determination; and
outputting, by the processor, the legacy signal by re-sampling the sampled signal comprising decrypted signal information from the digital signal to the analog signal.

13. The method of claim 10, further comprising:
determining, by the processor, a plurality of frame formats associated with the legacy signal, wherein the plurality of frame formats comprises at least one of a time slot and a burst code block, wherein the time slot corresponds to specific time intervals for a data transmission; and
shifting, by the processor, a carrier frequency (CF) within the time slot, based on determined plurality of frame formats.

14. The method of claim 11, further comprising:
shifting, by the processor, a carrier frequency (CF) for the sampled signal, wherein the shifted carrier frequency is agnostic to a frame format in the legacy signal.

15. The method of claim 11, further comprising:
synchronizing, by the processor, a predetermined hopping bandwidth with the in-line system;
assigning, by the processor, a set of keys for the predetermined hopping bandwidth based on a pre-determined hopping sequence; and
generating, by the processor, a burst range and a frequency range corresponding to the pre-determined hopping sequence based on the assigned set of keys and a burst duration of the in-line system.

16. The method of claim 15, further comprising:
synchronizing, by the processor, the burst range and the frequency range corresponding to the hopping sequence by configuring a modified frequency range of the in-line system.

17. The method of claim 10, further comprising:
identifying, by the processor, a plurality of burst boundaries associated with the legacy signal to initiate frequency hopping for the legacy signal, based on at least one of amplitude variations, phase shifts, and signal characteristics corresponding to variations; and
modifying, by the processor, a carrier frequency (CF) for data transmission of the legacy signal, at each start of a burst in the identified plurality of burst boundaries.

18. The method of claim 10, wherein the plurality of configuration parameters of the received legacy signal comprises at least one of a symbol timing, a burst timing, a frequency offset, a phase offset, a UW(s), a modulation/demodulation scheme, a center frequency, a symbol rate, a reception forward error correction rate (FEC), a reception roll off, and a reception signal power.

19. A non-transitory computer-readable medium comprising machine-readable instructions that are executable by a processor to:
establishing a communication channel between a modem and an in-line system via a communication network;
receiving a legacy signal from the modem, upon establishing the communication channel with the modem, wherein the legacy signal comprises a signal information, a channel requirement, and a modem configuration information;
determining a type of mode of operation associated with the in-line system based on the received legacy signal and the channel requirement;
determining a plurality of configuration parameters associated with a plurality of configurable components of the in-line system based on the determined type of mode of operation;
configuring a plurality of configurable components of the in-line system at a real-time with the determined plurality of configuration parameters;
executing at least one action in a sequence in each of the configured plurality of configurable components to process the received legacy signal, wherein the at least one action is determined based on the determined plurality of configuration parameters and the mode of operation; and
communicating the processed legacy signal to an external device via the established communication channel, wherein the communication channel comprises at least one of a random channel activity and a uniform channel activity associated with in-line system.

20. The non-transitory computer-readable medium of claim 19, wherein the at least one action comprises:
sampling the received legacy signal from an analog signal to a digital signal, to output a sampled signal corresponding to the legacy signal;
determining at least one of a legacy signal recovery action and a compression to be performed on the sampled signal, wherein the legacy signal recovery action comprises a demodulating action and a decoding action;
extracting the signal information from the sampled signal by performing at least one of the legacy signal recovery action and the compression, based on the determination, wherein the signal information comprises a plurality of symbols;
encrypting the signal information of the sampled signal, based on the at least one of the legacy signal recovery action and the compression performed;
ingesting the encrypted signal information onto the established communication channel by encoding and modulating the encrypted signal information using a modulating scheme;
classifying the modulated signal information into a plurality of symbols based on content of modulated signal information;
modifying a transmission frequency associated with the legacy signal over a time interval by performing a frequency hopping on the plurality of symbols; and
generating a re-sampled signal corresponding to the legacy signal based on the modified transmission frequency, wherein the re-sampled signal comprises a frequency hopped symbols.
